(19) United States
(12) Patent Application Publication
(10) Pub. No.: US 2026/0202649 A1
(43) Pub. Date: Jul. 16, 2026

(54) ZOOM LENS AND IMAGE PICKUP APPARATUS

(71) Applicant: CANON KABUSHIKI KAISHA, Tokyo (JP)

(72) Inventor: Makoto NAKAHARA, Tochigi (JP)

(21) Appl. No.: 19/414,375

(22) Filed: Dec. 10, 2025

(30) Foreign Application Priority Data
Jan. 16, 2025 (JP) 2025-005885

(51) Int. Cl. G02B 15/14

(52) U.S. Cl. CPC G02B 15/1455

(57) ABSTRACT

A zoom lens includes, in order from an object side to an image side, a first lens unit with negative refractive power, an intermediate group with negative refractive power including at least one lens unit, and a rear group with positive refractive power including a plurality of lens units. Each distance between adjacent lens units changes. The first lens unit does not move during zooming. An air gap between the intermediate group and the rear group may be maximized at a wide-angle end. The intermediate group may include a plurality of negative lenses. Predetermined inequalities may be satisfied.

### BACKGROUND

### Field of the Technology

The aspect of the disclosure relates to one or more embodiments of a zoom lens and an image pickup apparatus.

### Description of the Related Art

Zoom lenses for in image pickup apparatuses are demanded to have good optical performance over a wide angle of view. One example of a wide-angle zoom lens includes a negative lead type zoom lens in which a lens unit with negative refractive power is disposed closest to an object, as disclosed in Japanese Patent Laid-Open Publication No. 2023-104025.

### SUMMARY

One or more embodiments of a zoom lens according to one or more aspects of the disclosure may include, in order from an object side to an image side, a first lens unit with negative refractive power, an intermediate group with negative refractive power including at least one lens unit, and a rear group with positive refractive power including a plurality of lens units. Each distance between adjacent lens units may change. An air gap between the intermediate group and the rear group may be maximum at the wide-angle end. The intermediate group may include a plurality of negative lenses. The following inequalities may be satisfied:

−5.0≤DLNw/fL1≤−0.7

0.7≤MLP/fL1≤5.0

where fL1 is a focal length of the first lens unit, DLNw is a distance on an optical axis from a lens surface of the intermediate group closest to an object at the wide-angle end to a lens surface of the intermediate group closest to an image plane at the wide-angle end, and MLP is a maximum moving amount among the plurality of lens units included in the rear group during zooming from the wide-angle end to a telephoto end. An image pickup apparatus having the above zoom lens also constitute another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1.

FIGS. 2A, 2B, and 2C are aberration diagrams of the zoom lens according to Example 1.

FIG. 3 is a sectional view of a zoom lens according to Example 2.

FIGS. 4A, 4B, and 4C are aberration diagrams of the zoom lens according to Example 2.

FIG. 5 is a sectional view of a zoom lens according to Example 3.

FIGS. 6A, 6B, and 6C are aberration diagrams of the zoom lens according to Example 3.

FIG. 7 is a sectional view of a zoom lens according to Example 4.

FIGS. 8A, 8B, and 8C are aberration diagrams of the zoom lens according to Example 4.

FIG. 9 is a sectional view of a zoom lens according to Example 5.

FIGS. 10A, 10B, and 10C are aberration diagrams of the zoom lens according to Example 5.

FIG. 11 is a sectional view of a zoom lens according to Example 6.

FIGS. 12A, 12B, and 12C are aberration diagrams of the zoom lens according to Example 6.

FIG. 13 is a sectional view of a zoom lens according to Example 7.

FIGS. 14A, 14B, and 14C are aberration diagrams of the zoom lens according to Example 7.

FIG. 15 is a schematic diagram of an image pickup apparatus having any one of the zoom lenses according to Examples 1 to 7.

### DESCRIPTION OF THE EMBODIMENTS

Referring now to the accompanying drawings, a description will be given of embodiments according to the disclosure.

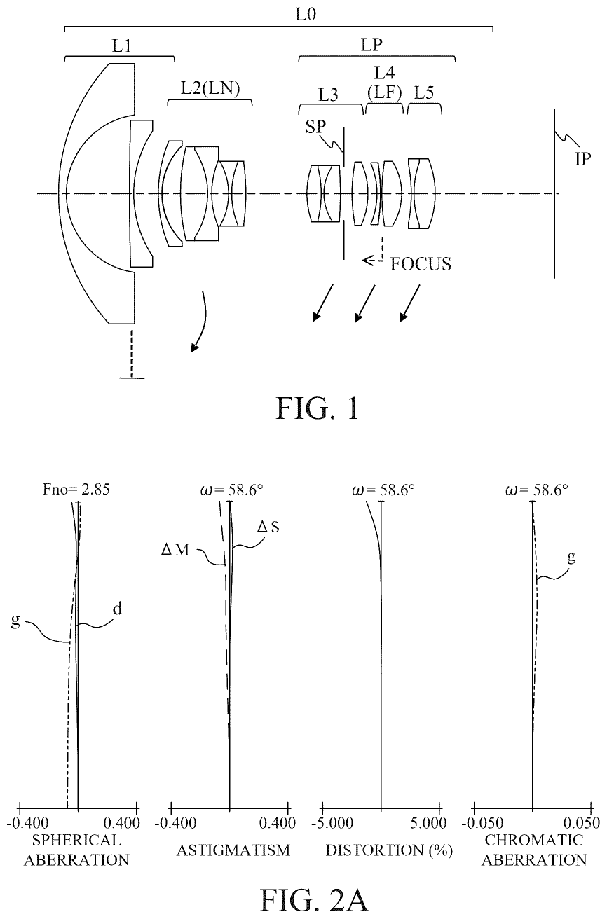

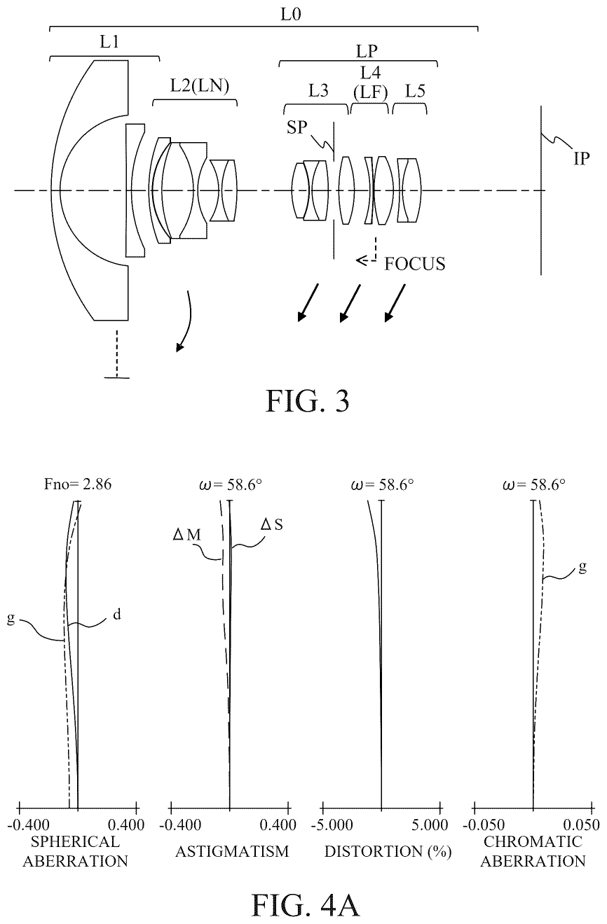

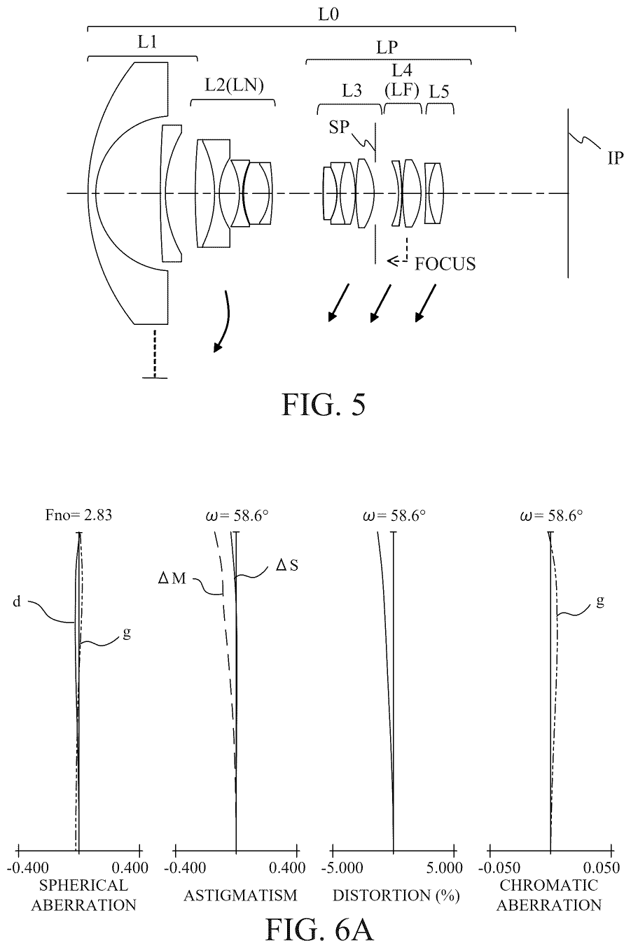

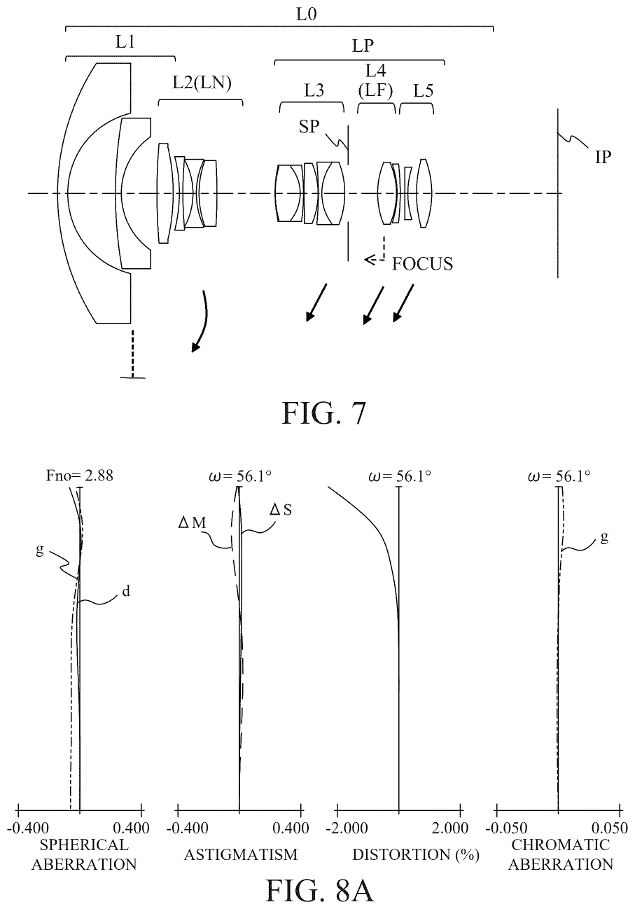

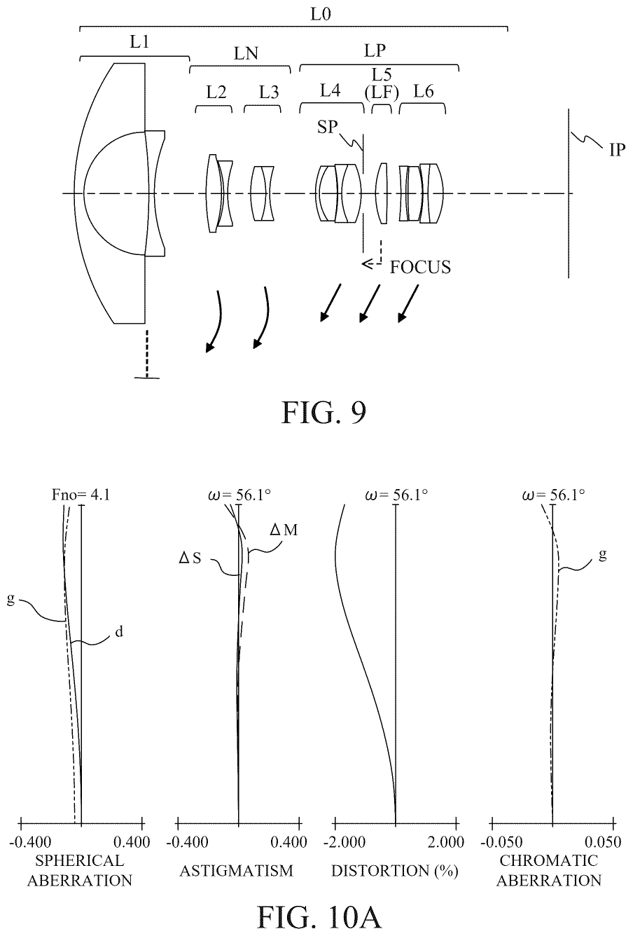

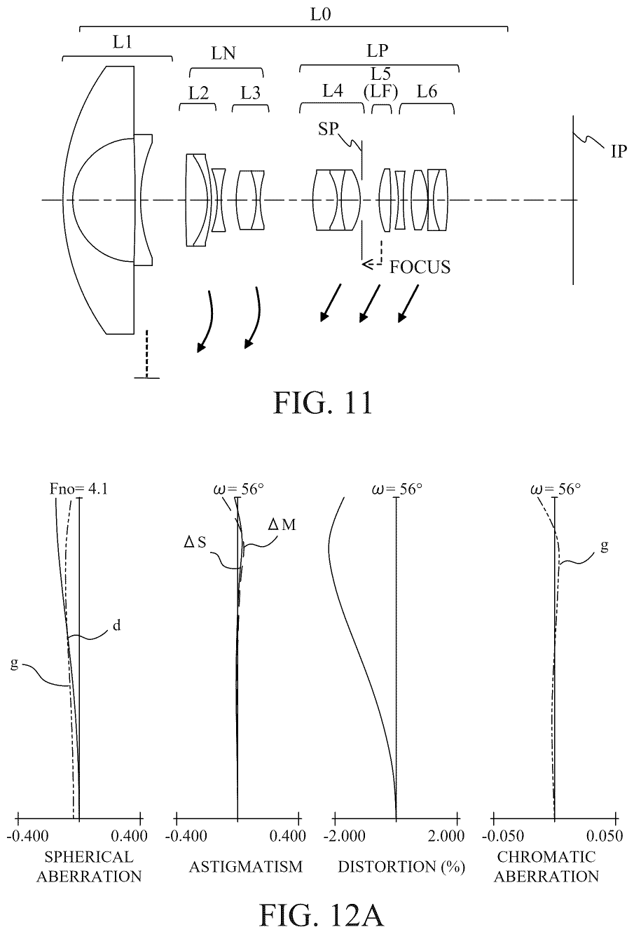

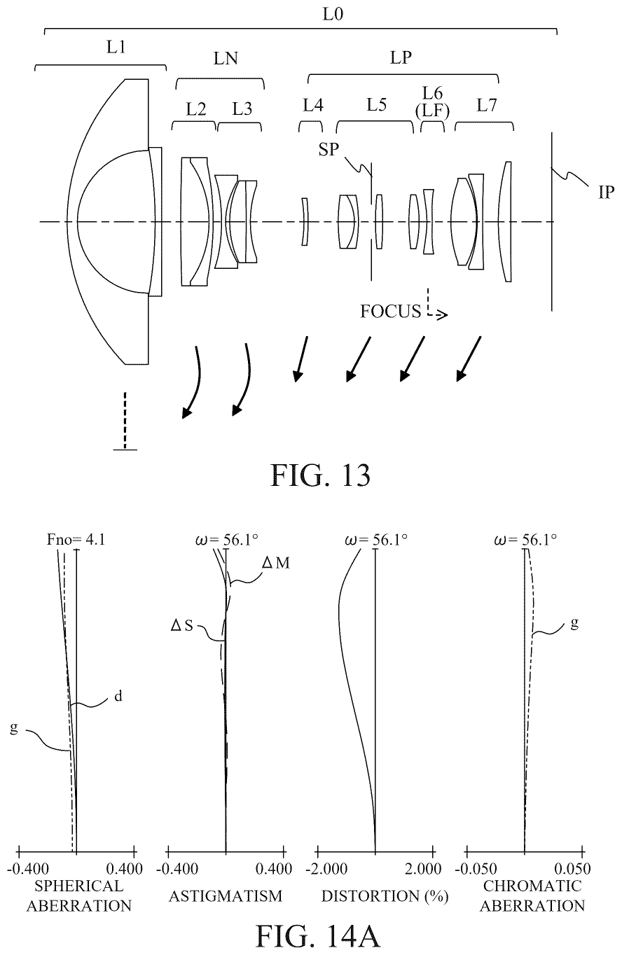

FIGS. 1, 3, 5, 7, 9, 11, and 13 illustrates cross sections of zoom lenses L0 according to Examples 1 to 7 at a wide-angle end in an in-focus state on an object at infinity (referred to as “in an in-focus state at infinity” hereinafter). The zoom lens L0 according to each example is used in an optical apparatus including an image pickup apparatus and an interchangeable lens, such as a digital video camera, a digital still camera, a broadcasting camera, a film-based camera, and a surveillance camera.

In each figure, a left side is an object side (front side), and a right side is an image side (rear side). The zoom lens L0 according to each example includes a plurality of lens units. In a zoom lens, a lens unit is a group of one or more lenses that may or may not move as a unit during magnification variation (zooming) between the wide-angle end and the telephoto end. In other words, a distance between adjacent lens units changes during zooming. The lens unit may include an aperture stop (diaphragm). The wide-angle end and telephoto end respectively indicate the zoom states with the maximum angle of view (shortest length) and minimum angle of view (longest focal length) when the lens unit that moves during zooming is disposed at both ends of a mechanically and controllably movable range in the optical axis direction. Regarding the number of lenses that constitute each lens unit, it is assumed that a cemented lens consisting of two lenses has two lenses.

In each diagram, Li represents an i-th (i=1, 2, 3, . . . ) lens unit included in the zoom lens L0, counted from the object side. For example, L1 indicates the first lens unit. LN is an intermediate group disposed closer to the image plane than the first lens unit L1. LP is a rear group disposed closer to the image plane than the intermediate group LN.

SP represents the aperture stop. IP is an image plane. An imaging surface (light receiving surface) of an image sensor such as a CCD sensor or CMOS sensor, or a film surface (photosensitive surface) of a silver film is located on the image plane IP.

In each figure, a solid arrow below the lens unit that moves during zooming indicates a moving locus of the lens unit during zooming from the wide-angle end to the telephoto end. A dashed arrow below the focus lens unit LF that moves during focusing indicates a moving direction of the lens unit during focusing from infinity to a close distance.

The zoom lens L0 according to each example includes, in order from the object side to the image side, a first lens unit L1 with negative refractive power, an intermediate group LN that includes at least one lens unit and has negative refractive power as a whole, and a rear group LP that includes a plurality of lens units and has positive refractive power as a whole. The intermediate group LN includes a plurality of negative lenses. In the zoom lens L0 according to each example, an air gap between the intermediate group LN and the rear group LP may be maximized at the wide-angle end. Thereby, a sufficient magnification variation ratio can be achieved.

The zoom lenses L0 according to Examples 1 to 4 include (consist of) the first lens unit L1, a second lens unit L2 with negative refractive power, a third lens unit L3 with positive refractive power, a fourth lens unit L4 with positive refractive power, and a fifth lens unit L5 with negative refractive power. The second lens unit L2 constitutes the intermediate group LN, and the third lens unit L3, fourth lens unit L4, and fifth lens unit L5 constitute the rear group LP. The third lens unit L3 includes an aperture stop SP.

During zooming from the wide-angle end to the telephoto end, the first lens unit L1 does not move, and the second lens unit L2 moves toward the image side and then toward the object side. The third lens unit L3, fourth lens unit L4, and fifth lens unit L5 move monotonically toward the object side. During focusing from infinity to a close distance, the fourth lens unit L4 moves toward the object side.

The zoom lens L0 according to Example 5 includes (consists of) the first lens unit L1, a second lens unit L2 with negative refractive power, a third lens unit L3 with positive refractive power, a fourth lens unit L4 with positive refractive power, a fifth lens unit L5 with positive refractive power, and a sixth lens unit L6 with negative refractive power. The second lens unit L2 and the third lens unit L3 form the intermediate group LN, and the fourth lens unit L4, the fifth lens unit L5, and the sixth lens unit L6 form the rear group LP. The fourth lens unit L4 includes an aperture stop SP.

During zooming from the wide-angle end to the telephoto end, the first lens unit L1 does not move, while the second lens unit L2 and the third lens unit L3 move toward the image side and then toward the object side. The fourth lens unit L4, the fifth lens unit L5, and the sixth lens unit L6 move monotonically toward the object side. During focusing from infinity to a close distance, the fifth lens unit L5 moves toward the object side.

The zoom lens L0 according to Example 6 includes (consist of) the first lens unit L1, a second lens unit L2 with positive refractive power, a third lens unit L3 with negative refractive power, a fourth lens unit L4 with positive refractive power, a fifth lens unit L5 with positive refractive power, and a sixth lens unit L6 with negative refractive power. The second lens unit L2 and the third lens unit L3 form the intermediate group LN, and the fourth lens unit L4, the fifth lens unit L5, and the sixth lens unit L6 form the rear group LP. The fourth lens unit L4 includes an aperture stop SP.

During zooming from the wide-angle end to the telephoto end, the first lens unit L1 does not move, while the second lens unit L2 and the third lens unit L3 move toward the image side and then toward the object side. The fourth lens unit L4, the fifth lens unit L5, and the sixth lens unit L6 move monotonically toward the object side. During focusing from infinity to a close distance, the fifth lens unit L5 moves toward the object.

The zoom lens L0 according to Example 7 includes (consists of) a first lens unit L1, a second lens unit L2 with positive refractive power, a third lens unit L3 with negative refractive power, a fourth lens unit L4 with negative refractive power, a fifth lens unit L5 with positive refractive power, a sixth lens unit L6 with negative refractive power, and a seventh lens unit L7 with positive refractive power. The second lens unit L2 and the third lens unit L3 form the intermediate group LN, and the fourth lens unit L4, the fifth lens unit L5, the sixth lens unit L6, and the seventh lens unit L7 form the rear group LP. The fifth lens unit L5 includes an aperture stop SP.

During zooming from the wide-angle end to the telephoto end, the first lens unit L1 does not move, and the second lens unit L2 and the third lens unit L3 move toward the image side and then toward the object side. The fourth lens unit L4, the fifth lens unit L5, and the sixth lens unit L6 move monotonically toward the object side. During focusing from infinity to a close distance, the sixth lens unit L6 moves toward the image side.

The projection method of the zoom lenses according to Examples 1 to 3 is the equiangular (equidistant) projection method (Y=fθ), while the projection method of the zoom lenses in Examples 4 to 7 is the equisolid angle projection method (Y=2f sin (θ/2)). Other projection methods may also be used.

The zoom lens L0 according to each example may have an optical block such as a parallel plate with no refractive power, such as a low-pass filter or infrared cut filter, between the lens closest to the image and the image plane IP.

Next, the characteristics of the zoom lens L0 according to each example will be described. The zoom lens L0 according to each example is a negative lead type zoom lens in which the refractive power of the first lens unit L1 is negative. Negative lead type zoom lenses are particularly effective for achieving wide angles.

However, in the negative lead type zoom lenses, the lens configuration tends to be asymmetric with respect to the aperture stop SP, and it becomes difficult to correct a variety of aberrations. As the angle of view increases, the height of off-axis rays entering the first lens unit L1 increases, which in turn increases the diameter and weight of the first lens unit L1. Thus, in this embodiment, the first lens unit L1 is fixed (stationary) relative to the image plane IP during zooming, thereby enhancing the robustness of the zoom lens.

To achieve good optical performance by keeping the first lens unit L1 stationary during zooming, it is important to properly configure the intermediate group LN and rear group LP. In this example, the intermediate group LN includes a plurality of negative lenses. Thereby, lateral chromatic aberration and distortion can be suppressed. The rear group LP includes a plurality of lens units, achieving good optical performance and a sufficient magnification variation ratio (e.g., approximately 2×). Since the height of off-axis rays entering the rear group LP is relatively low, the diameter of the rear group LP tends to be small. Therefore, disposing the focus lens unit LF within the rear group LP can easily reduce the size of the focus lens unit LF and increase the focusing speed.

The zoom lens L0 according to each example may satisfy the following inequalities (1) and (2):

$$- 5. \leq DLNw / fL 1 \leq - 0.7 \qquad ( 1 )$$

$$0.7 \leq MLP / fL 1 \leq 5. \qquad ( 2 )$$

where fL1 is a focal length of the first lens unit L1, DLNw is an on-axis distance from a lens surface of the intermediate group LN closest to the object at the wide-angle end to a lens surface closest to the image plane at the wide-angle end, and MLP is the largest moving amount MLP of the plurality of lens units included in the rear group LP during zooming from the wide-angle end to the telephoto end.

Inequality (1) defines a proper relationship between the focal length fL1 of the first lens unit L1 and the distance DLNw, which is the thickness of the intermediate group LN at the wide-angle end. In order to capture light rays from a wide angle of view and guide them to the image plane, the intermediate group LN may have many lens surfaces. In wide-angle zoom lenses, the height of off-axis light rays entering the intermediate group LN increases, and off-axis aberrations such as chromatic aberration of magnification and distortion within the intermediate group LN increase. To suppress these aberrations, the intermediate group LN may have a proper thickness. In a case where the thickness increases and DLNw/fL1 becomes lower than the lower limit of inequality (1), it becomes difficult to reduce the size of the zoom lens. In a case where the thickness of the intermediate group LN is reduced and DLNw/fL1 becomes higher than the upper limit of inequality (1), it becomes difficult to correct off-axis aberrations such as lateral chromatic aberration and distortion.

The lower limit of inequality (1) may be replaced with −2.4, −2.2, −2.0, −1.8, or −1.6. The upper limit of inequality (1) may be replaced with −0.75, −0.8, −0.85, or −0.9.

Inequality (2) defines a proper relationship between the largest moving amount MLP of the plurality of lens units included in the rear group LP during zooming from the wide-angle end to the telephoto end and the focal length fL1 of the first lens unit L1. A moving amount of a lens unit is a difference between the position of that lens unit at the wide-angle end and the position of that lens unit at the telephoto end, not including the reciprocating amount. It is considered positive when that lens unit is located closer to the image plane at the telephoto end than at the wide-angle end.

In a case where the moving amount MLP is reduced and MLP/fL1 becomes lower than the lower limit of inequality (2), it becomes difficult to ensure a sufficient magnification variation ratio. In a case where the moving amount MLP increases and MLP/fL1 becomes higher than the upper limit of inequality (2), it becomes difficult to miniaturize the zoom lens.

The lower limit of inequality (2) may be replaced with 0.8, 0.9, 1.0, or 1.1. The upper limit of inequality (2) may be replaced with 4.0, 3.0, 2.0, 1.8, 1.6, or 1.4.

Satisfying the above configurations and inequality enables a zoom lens to have a reduced size and good optical performance.

The zoom lens L0 according to each example may satisfy at least one of the following inequalities (3) to (14):

$$- 3.3 \leq fL 1 / fw \leq - 1.7 \qquad ( 3 )$$

$$2. \leq fLNw / fL 1 \leq 3.5 \qquad ( 4 )$$

$$1.4 \leq fG 1 / fL 1 \leq 3. \qquad ( 5 )$$

$$0.2 \leq fG 1 / fG 2 \leq 1.6 \qquad ( 6 )$$

$$3.5 \leq fLF / fw \leq 15. \qquad ( 7 )$$

$$- 4.1 \leq fLF / fL 1 \leq - 1.8 \qquad ( 8 )$$

$$- 1.3 \leq fL 1 / fLPw \leq - 0.4 \qquad ( 9 )$$

$$1.3 \leq Skw / fw \leq 6. 0 \qquad ( 10 )$$

$$0.39 \leq DSPw / Skw \leq 2.90 \qquad ( 11 )$$

$$1.65 \leq ndG 1 \leq 2.2 \qquad ( 12 )$$

$$1.3 \leq ( R 1 + R 2 ) / ( R 1 - R 2 ) \leq 3. \qquad ( 13 )$$

$$1.5 \leq Yta / Ywa \leq 3. \qquad ( 14 )$$

Inequality (3) defines a proper relationship between the focal length fL1 of the first lens unit L1 and a focal length fw of the zoom lens L0 at the wide-angle end. Properly setting the focal length fL1 of the first lens unit L1 can easily correct lateral chromatic aberration and curvature of field while suppressing distortion. Increasing the focal length fL1 of the first lens unit L1 so that fL1/fw becomes lower than the lower limit of inequality (3) is advantageous for aberration correction, but it becomes difficult to achieve a wide angle and reduce the size of the optical system. In addition, the diameter of the first lens unit L1 is likely to increase, and it becomes difficult to reduce the size of the optical system. In a case where the focal length fL1 of the first lens unit L1 is reduced so that fL1/fw becomes higher than the upper limit of inequality (3), the image height change due to off-axis coma increases, and it becomes difficult to correct curvature of field and astigmatism.

The lower limit of inequality (3) may be replaced with −3.4, −3.3, −3.2, −3.1, or −3.0. The upper limit of inequality (3) may be replaced with −1.8, −1.9, or −2.0.

Inequality (4) defines a proper relationship between a focal length fLNw of the intermediate group LN and the focal length fL1 of the first lens unit L1 at the wide-angle end. Increasing the focal length fL1 of the first lens unit L1 so that fLNw/fL1 becomes lower than the lower limit of inequality (4) is advantageous for aberration correction, but it becomes difficult to achieve a wider angle and reduce the size of the optical system. This is likely to increase the diameter of the first lens unit L1, and it becomes difficult to reduce the size of the optical system. In a case where the focal length fL1 of the first lens unit L1 is reduced so that fLNw/fL1 becomes higher than the upper limit of inequality (4), the image height change due to off-axis coma increases, and it becomes difficult to correct curvature of field and astigmatism.

The lower limit of inequality (4) may be replaced with 2.1 or 2.2. The upper limit of inequality (4) may be replaced with 3.1 or 3.0.

Inequality (5) defines a proper relationship between a focal length fG1 of the first lens G1, which is closest to the object in the first lens unit L1, and the focal length fL1 of the first lens unit L1. The first lens G1 is a negative lens. In a case where the focal length fG1 of the first lens G1 is reduced so that fG1/fL1 becomes lower than the lower limit of inequality (5), it becomes difficult to correct curvature of field and distortion. In a case where the focal length fG1 of the first lens G1 is increased so that fG1/fL1 becomes higher than the upper limit of inequality (5), it is advantageous for aberration correction, but it becomes difficult to achieve a wide angle and reduce the size. This is likely to increase the diameter of the first lens unit L1, and it becomes difficult to reduce the size of the optical system.

The lower limit of inequality (5) may be replaced with 1.5, 1.6, or 1.7. The upper limit of inequality (5) may be replaced with 2.9, 2.8, 2.7, or 2.6.

Inequality (6) defines a proper relationship between the focal length fG1 of the first lens G1 in the first lens unit L1 and a focal length fG2 of the second lens G2 adjacent to the first lens G1 on the image side. In a case where the first and second lenses G1 and G2 are arranged as negative lenses in the first lens unit L1, from the object side, to achieve a wider angle of view, and the focal length fG1 of the first lens G1 is reduced so that fG1/fG2 becomes lower than the lower limit of inequality (6), it becomes difficult to correct curvature of field and distortion. In a case where the focal length fG1 of the first lens G1 increases so that fG1/fG2 becomes higher than the upper limit of inequality (6), this is advantageous for aberration correction, but it becomes difficult to achieve a wider angle of view and reduce the size. In addition, this is likely to increase the diameter of the first lens unit L1, and it becomes difficult to reduce the size of the optical system.

The lower limit of inequality (6) may be replaced with 0.30, 0.40, 0.45, or 0.48. The upper limit of inequality (6) may be replaced with 1.50, 1.40, 1.30, or 1.20.

Inequality (7) defines a proper relationship between a focal length fLF of the focus lens unit LF and the focal length fw of the zoom lens L0 at the wide-angle end. In a case where the focal length fLF of the focus lens unit LF is reduced so that fLF/fw becomes lower than the lower limit of inequality (7), it becomes difficult to suppress various aberration fluctuations, including spherical aberration, that occur during focusing. In a case where the focal length fLF of the focus lens unit LF increases so that fLF/fw becomes higher than the upper limit of inequality (7), the moving amount of the focus lens unit LF during focusing increases, and it becomes difficult to reduce the size of the optical system.

The lower limit of inequality (7) may be replaced with 3.8, 4.0, 4.2, 4.4, 4.6, or 4.8. The upper limit of inequality (7) may be replaced with 12.0, 11.0, 10.0, 9.0, 8.1, or 7.9.

Inequality (8) defines a proper relationship between the focal length fLF of the focus lens unit LF and the focal length fL1 of the first lens unit L1. In a case where the focal length fLF of the focus lens unit LF increases so that fLF/fL1 becomes lower than the lower limit of inequality (8), the moving amount of the focus lens unit LF during focusing increases, and it becomes difficult to reduce the size of the optical system. In a case where the focal length fLF of the focus lens unit LF is reduced so that fLF/fL1 becomes higher than the upper limit of inequality (8), it becomes difficult to suppress various aberration fluctuations, including spherical aberration, that occur during focusing.

The lower limit of inequality (8) may be replaced with −4.0, −3.9, −3.8, −3.7, or −3.6. The upper limit of inequality (8) may be replaced with −1.9, −2.0, −2.1, or −2.2.

Inequality (9) defines a proper relationship between the focal length fL1 of the first lens unit L1 and a focal length fLPw of the rear group LP at the wide-angle end. In a case where the focal length fL1 of the first lens unit L1 increases so that fL1/fLPw becomes lower than the lower limit of inequality (9), the convergence action of the rear group LP increases, and the secondary spectra of lateral chromatic aberration and longitudinal chromatic aberration in the rear group LP tend to increase. In a case where the focal length fL1 of the first lens unit L1 is reduced so that fL1/fLPw becomes higher than the upper limit of inequality (9), it will become difficult to correct spherical aberration and coma in the rear group LP.

The lower limit of inequality (9) may be replaced with −1.2, −1.1, or −1.0. The upper limit of inequality (9) may be replaced with −0.45, −0.46, or −0.47. Inequality (10) defines a proper relationship between an air-equivalent distance (back focus) Skw on the optical axis from the lens surface closest to the image plane of the zoom lens L0 to the image plane IP at the wide-angle end, and the focal length fw of the zoom lens L0 at the wide-angle end. In a case where the back focus SKw is reduced so that Skw/fw becomes lower than the lower limit of inequality (10), it becomes difficult to place an optical element such as a low-pass filter near the image sensor disposed on the image plane. In a case where the back focus SKw is increased so that Skw/fw becomes higher than the upper limit of inequality (10), the overall optical length of the zoom lens L0 at the wide-angle end increases, and it becomes difficult to reduce its size.

The lower limit of inequality (10) may be replaced with 1.35, 2.0, 3.0, 4.0, 4.3, or 4.4. The upper limit of inequality (10) may be replaced with 5.8, 5.6, 5.4, 5.2, 5.0, 4.9, or 4.8.

Inequality (11) defines a proper relationship between an on-axis distance DSPw from the aperture stop SP provided in the rear group LP to a lens surface in the rear group LP (i.e., the zoom lens L0) closest to the image plane, and the back focus Skw at the wide-angle end. In a case where the distance DSPw is reduced so that DSPw/Skw becomes lower than the lower limit of inequality (11), it becomes difficult to place the focus lens unit LF within the rear group LP. In a case where the back focus SKw is increased so that DSPw/Skw becomes higher than the upper limit of inequality (11), the overall optical length of the zoom lens L0 at the wide-angle end increases, and it becomes difficult to reduce its size.

The lower limit of inequality (11) may be replaced with 0.40, 0.41, or 0.42. The upper limit of inequality (11) may be replaced with 2.00, 1.00, 0.85, or 0.79.

Inequality (12) defines a proper range for a refractive index ndG1 at the d-line of the first lens G1, which is closest to the object in the first lens unit L1. Due to the characteristics of glass, which is the material of the first lens G1, as the refractive index increases, the Abbe number decreases, and it becomes insufficient to correct lateral chromatic aberration. As a result, the refractive power of the first lens G1 is reduced to suppress chromatic aberration, which increases the overall optical length of the zoom lens L0. In an attempt to reduce the number of lenses to reduce the size of a retrofocus type zoom lens, a Petzval sum tends to become negative, the image plane tends to tilt toward the overexposure side, and astigmatic difference tends to increase. Therefore, it is important to properly set the refractive index of the first lens G1 as a negative lens to effectively correct curvature of field and astigmatic difference. In a case where ndG1 becomes lower than the lower limit of inequality (12), the refractive power of the negative lens may be reduced to correct curvature of field, the back focus increases, and it becomes difficult to reduce the size of the zoom lens L0. In a case where ndG1 becomes higher than the upper limit of inequality (12), it becomes easy to correct curvature of field, but it becomes difficult to simultaneously correct distortion and lateral chromatic aberration.

The lower limit of inequality (12) may be replaced with 1.68, 1.71, or 1.74. The upper limit of inequality (12) may be replaced with 2.10, 2.06, 2.01, or 1.98.

Inequality (13) defines a proper shape (shape factor) of the first lens G1. R1 is a radius of curvature of an object-side lens surface of the first lens G1, and R2 is a radius of curvature of an image-side lens surface of the first lens G1. In a case where the shape factor (R1+R2)/(R1−R2) becomes lower than the lower limit of inequality (13), the refractive power of the first lens G1 increases, and it becomes difficult to achieve high optical performance. In a case where the shape factor becomes higher than the upper limit of inequality (13), the refractive power of the first lens G1 is reduced, and it becomes difficult to achieve a wide angle of view.

The lower limit of inequality (13) may be replaced with 1.4, 1.5, 1.6, or 1.7. The upper limit of inequality (13) may be replaced with 2.8, 2.7, 2.6, or 2.5.

Inequality (14) defines a proper relationship between a maximum effective image height Yta at the telephoto end and a maximum effective image height Ywa at the wide-angle end. The maximum effective image height is a distance from the optical axis to an image point farthest from the optical axis that can be captured by an image sensor or silver film. In a case where the maximum effective image height Yta at the telephoto end is reduced so that Yta/Ywa becomes lower than the lower limit of inequality (14), it becomes difficult to achieve a wide-angle zoom lens that includes a circular fisheye lens and a diagonal fisheye lens. In a case where the maximum effective image height Yta at the telephoto end increases so that Yta/Ywa becomes higher than the upper limit of inequality (14), the moving amount or refractive power of each lens unit that moves during zooming increases, and it becomes difficult to suppress various aberration fluctuations during zooming.

The lower limit of inequality (14) may be replaced with 1.6, 1.7, 1.8, or 1.9. The upper limit of inequality (14) may be replaced with 2.8, 2.6, 2.5, 2.3, or 2.1.

Next follows the configuration that may be satisfied in the zoom lens L0 according to each example.

The first lens unit L1 may have two or more negative lenses, arranged in order from the object side, and the first lens (negative lens) G1 closest to the object may have a meniscus shape with its convex surface toward the object side. Thereby, a sufficiently wide angle can be achieved. In this case, in a case where the first lens G1 is held by an unillustrated barrel, the surface vertex on the object side of the first lens G1 may be located closer to the object than that barrel.

The object-side lens surface and image-side lens surface of the first lens G1 may be spherical. Thereby, it becomes easier to manufacture the zoom lens while the required optical performance is obtained. To facilitate manufacturing, all lenses in the first lens unit L1 may be spherical lenses and the first lens unit L1 may include two negative lenses.

The focus lens unit LF may be located closer to the image plane than the aperture stop SP and include two or fewer lenses. Thereby, it becomes easy to reduce the size of the focus lens unit LF and achieve faster focusing.

The rear group LP may include three or more lens units that move so that the distance between them changes during zooming. Thereby, a sufficient magnification variation ratio may be achieved.

The following inequality enables the required angle of view for a fisheye zoom lens or ultra-wide-angle zoom lens to be obtained:

$$85 \leq ω w$$

where ωw(°) is a half angle of view of the zoom lens L0 in an in-focus state at infinity at the wide-angle end.

Numerical examples 1 to 7 corresponding to Examples 1 to 7 will now be illustrated. In the surface data for each numerical example, the surface number i indicates the order of the optical surface counted from the object side. r represents a radius of curvature of an i-th optical surface (mm), d represents a lens thickness or air gap (mm) on the optical axis between i-th and (i+1)-th surfaces, and nd represents a refractive index for the d-line of the optical material between i-th and (i+1)-th surfaces. vd represents an Abbe number based on the d-line of the optical material between i-th and (i+1)-th surfaces. The Abbe number vd based on the d-line is expressed as follows:

$$ν d = ( Nd - 1 ) / ( NF - NC )$$

where Nd, NF, and NC are the refractive indices for the d-line (587.6 nm), F-line (486.1 nm), and C-line (656.3 nm) in the Fraunhofer lines.

In each numerical example, d, focal length (mm), F-number, and half angle of view) (° are all values for the zoom lens in an in-focus state at infinity. BF represents back focus (mm), which is the air-equivalent distance on the optical axis from the lens surface closest to the image plane (final surface) of a zoom lens to the paraxial image plane, as discussed above. BF at the wide-angle end corresponds to Skw in inequality (10). An overall lens length is an on-axis distance from a lens surface closest to an object to a final surface of the zoom lens plus the back focus, and is also known as an overall optical length.

An asterisk “*” next to a surface number indicates that the surface has an aspherical shape. The aspherical shape is expressed by the following equation:

$$X = ( {h}^{2} / R ) / \{ 1 + {[ 1 - ( 1 + K ) {( h / R )}^{2} ]}^{1 / 2} \} + A 4 \times {h}^{4} + A 6 \times {h}^{6} + A 8 \times {h}^{8} + A 10 \times {h}^{10} + A 12 \times {h}^{12} + A 14 \times {h}^{14}$$

where X is a displacement amount from a surface vertex in the optical axis direction, h is a height from the optical axis in a direction orthogonal to the optical axis, a light traveling direction is positive, R is a paraxial radius of curvature, K is a conic constant, and A4 to A14 are aspherical coefficients.

The “e±x” in the conic constant and aspherical coefficients means×10^{±x}.

### Numerical Example 1

UNIT: mm
SURFACE DATA

| Surface No. | r | d | nd | νd |
|---|---|---|---|---|
| 1 | 48.932 | 2.00 | 1.85150 | 40.8 |
| 2 | 20.284 | 16.25 | | |
| 3 | 557.363 | 1.10 | 1.80400 | 46.5 |
| 4 | 28.772 | (Variable) | | |
| 5 | 34.855 | 0.90 | 1.85896 | 22.7 |
| 6 | 17.068 | 0.10 | 1.53344 | 52.7 |
| 7* | 17.589 | 4.70 | | |
| 8 | 50.857 | 6.99 | 1.83400 | 37.2 |
| 9 | −20.635 | 1.05 | 1.49700 | 81.7 |
| 10 | 22.129 | 4.34 | | |
| 11 | −16.265 | 0.80 | 1.49700 | 81.7 |
| 12 | 21.161 | 3.64 | 1.66565 | 35.6 |
| 13 | −55.693 | (Variable) | | |
| 14 | 21.234 | 3.68 | 1.63980 | 34.5 |
| 15 | −27.788 | 0.70 | 1.90043 | 37.4 |
| 16 | 12.518 | 4.24 | 1.59270 | 35.3 |
| 17 | −87.908 | 0.91 | | |
| 18 (SP) | ∞ | 2.09 | | |
| 19 | 42.390 | 4.09 | 1.49700 | 81.7 |
| 20 | −19.741 | (Variable) | | |
| 21 | −19.756 | 0.90 | 2.00100 | 29.1 |
| 22 | −46.915 | 0.10 | 1.53344 | 52.7 |
| 23* | −32.818 | 0.25 | | |
| 24 | 49.974 | 5.10 | 1.49700 | 81.7 |
| 25 | −15.524 | (Variable) | | |
| 26 | −39.407 | 0.70 | 1.81600 | 46.6 |
| 27 | 24.127 | 5.47 | 1.49700 | 81.7 |
| 28 | −23.248 | (Variable) | | |
| Image Plane | ∞ | | | |

ASPHERIC DATA
7th Surface
K = 0.00000e+00 A 4 = 4.48181e−07 A 6 = 3.99220e−08
A 8 = −9.08985e−11 A10 = 1.59194e−12 A12 = −4.38981e−15
23rd Surface
K = 0.00000e+00 A 4 = 6.12566e−05 A 6 = 1.17826e−07
A 8 = 2.22470e−09 A10 = −3.70114e−11 A12 = 2.37590e−13

VARIOUS DATA
ZOOM RATIO 2.00

| | WIDE | MIDDLE | TELE |
|---|---|---|---|
| Focal Length | 6.81 | 9.58 | 13.60 |
| Fno | 2.85 | 3.23 | 3.60 |
| Half Angle of View (°) | 58.57 | 57.09 | 57.85 |
| Image Height | 11.15 | 14.80 | 21.64 |
| Overall Lens Length | 127.71 | 127.71 | 127.71 |
| BF | 30.73 | 40.08 | 49.42 |
| d4 | 6.34 | 6.31 | 2.10 |
| d13 | 15.72 | 6.40 | 1.27 |
| d20 | 2.33 | 3.71 | 3.67 |
| d25 | 2.47 | 1.10 | 1.14 |
| d28 | 30.73 | 40.08 | 49.42 |

LENS UNIT DATA

| Lens Unit | Starting Surface | Focal Length |
|---|---|---|
| 1 | 1 | −16.55 |
| 2 | 5 | −42.17 |
| 3 | 14 | 26.64 |
| 4 | 21 | 47.74 |
| 5 | 26 | −101.75 |

### Numerical Example 2

UNIT: mm
SURFACE DATA

| Surface No. | r | d | nd | νd |
|---|---|---|---|---|
| 1 | 55.485 | 2.30 | 1.85150 | 40.8 |
| 2 | 19.371 | 17.05 | | |
| 3 | −1103.546 | 1.30 | 1.90525 | 35.0 |
| 4 | 34.645 | (Variable) | | |
| 5 | 37.524 | 0.90 | 1.89286 | 20.4 |
| 6 | 18.491 | 0.10 | 1.58946 | 30.6 |
| 7* | 18.199 | 2.37 | | |
| 8 | 31.026 | 8.14 | 1.78880 | 28.4 |
| 9 | −20.624 | 1.10 | 1.49700 | 81.7 |
| 10 | 16.423 | 5.40 | | |
| 11 | −14.389 | 0.80 | 1.49700 | 81.7 |
| 12 | 18.091 | 3.89 | 1.61340 | 44.3 |
| 13 | −39.413 | (Variable) | | |
| 14 | 18.952 | 4.42 | 1.53172 | 48.8 |
| 15 | −17.614 | 0.09 | | |
| 16 | −17.868 | 0.70 | 1.88300 | 40.8 |
| 17 | 15.902 | 4.19 | 1.59270 | 35.3 |
| 18 | −41.659 | 1.44 | | |
| 19 (SP) | ∞ | 1.27 | | |
| 20 | 34.703 | 4.01 | 1.49700 | 81.7 |
| 21 | −25.217 | (Variable) | | |
| 22 | −26.388 | 0.80 | 1.88300 | 40.8 |
| 23 | −78.439 | 0.10 | 1.53344 | 52.7 |
| 24* | −49.028 | 0.15 | | |
| 25 | 31.715 | 4.97 | 1.49700 | 81.7 |
| 26 | −18.785 | (Variable) | | |
| 27 | −53.258 | 0.75 | 1.88300 | 40.8 |
| 28 | 19.564 | 4.78 | 1.49700 | 81.7 |
| 29 | −25.590 | (Variable) | | |
| Image Plane | ∞ | | | |

ASPHERIC DATA
7th Surface
K = 0.00000e+00 A 4 = −9.88827e−06 A 6 = 6.80002e−09
A 8 = −9.44113e−12 A10 = 1.04890e−12 A12 = −2.43934e−15
24th Surface
K = 0.00000e+00 A 4 = 5.68392e−05 A 6 = 1.09227e−07
A 8 = 3.24013e−10 A10 = 1.13582e−12 A12 = −2.42531e−14

VARIOUS DATA
ZOOM RATIO 1.97

| | WIDE | MIDDLE | TELE |
|---|---|---|---|
| Focal Length | 6.80 | 9.52 | 13.41 |
| Fno | 2.86 | 3.22 | 3.61 |
| Half Angle of View (°) | 58.61 | 57.24 | 58.16 |
| Image Height | 11.15 | 14.80 | 21.60 |
| Overall Lens Length | 126.11 | 126.11 | 126.11 |
| BF | 30.90 | 39.23 | 47.55 |
| d4 | 4.47 | 5.13 | 1.29 |
| d13 | 14.12 | 5.13 | 0.65 |
| d21 | 4.03 | 3.69 | 2.74 |
| d26 | 1.58 | 1.92 | 2.87 |
| d29 | 30.90 | 39.23 | 47.55 |

LENS UNIT DATA

| Lens Unit | Starting Surface | Focal Length |
|---|---|---|
| 1 | 1 | −14.82 |
| 2 | 5 | −38.96 |
| 3 | 14 | 27.05 |
| 4 | 22 | 39.68 |
| 5 | 27 | −68.35 |

### Numerical Example 3

UNIT: mm
SURFACE DATA

| Surface No. | r | d | nd | νd |
|---|---|---|---|---|
| 1 | 52.863 | 2.00 | 1.85150 | 40.8 |
| 2 | 19.811 | 16.64 | | |
| 3 | 268.068 | 1.30 | 2.00100 | 29.1 |
| 4 | 31.150 | (Variable) | | |
| 5 | 159.698 | 4.99 | 1.95375 | 32.3 |
| 6 | −30.207 | 1.20 | 1.49700 | 81.7 |
| 7 | 16.611 | 5.20 | | |
| 8 | −17.533 | 0.80 | 1.49700 | 81.7 |
| 9 | 18.643 | 0.28 | | |
| 10 | 19.966 | 6.58 | 1.78880 | 28.4 |
| 11 | −12.466 | 0.80 | 2.00100 | 29.1 |
| 12 | −61.500 | (Variable) | | |
| 13* | 55.457 | 0.10 | 1.58946 | 30.6 |
| 14 | 97.068 | 3.52 | 1.56732 | 42.8 |
| 15 | −14.576 | 0.05 | | |
| 16 | −14.461 | 0.80 | 2.00100 | 29.1 |
| 17 | 22.989 | 3.89 | 1.59270 | 35.3 |
| 18 | −25.500 | 0.15 | | |
| 19 | 52.181 | 4.70 | 1.63980 | 34.5 |
| 20 | −16.612 | 0.30 | | |
| 21 (SP) | ∞ | (Variable) | | |
| 22 | −20.107 | 0.80 | 1.95375 | 32.3 |
| 23 | −48.225 | 0.10 | 1.58946 | 30.6 |
| 24* | −37.531 | 0.15 | | |
| 25 | 48.217 | 4.74 | 1.49700 | 81.7 |
| 26 | −16.669 | (Variable) | | |
| 27 | −101.305 | 0.80 | 1.88300 | 40.8 |
| 28 | 18.672 | 3.74 | 1.49700 | 81.7 |
| 29 | −30.910 | (Variable) | | |
| Image Plane | ∞ | | | |

ASPHERIC DATA
13th Surface
K = 0.00000e+00 A 4 = −5.40095e−05 A 6 = −1.58648e−07
A 8 = −6.84435e−09 A10 = 1.41530e−10 A12 = −1.69897e−12
24th Surface
K = 0.00000e+00 A 4 = 3.89315e−05 A 6 = 1.19235e−07
A 8 = −4.99023e−10 A10 = 1.75021e−11 A12 = −1.12723e−13

VARIOUS DATA
ZOOM RATIO 1.97

| | WIDE | MIDDLE | TELE |
|---|---|---|---|
| Focal Length | 6.82 | 9.56 | 13.42 |
| Fno | 2.83 | 3.21 | 3.60 |
| Half Angle of View (°) | 58.56 | 57.15 | 58.14 |
| Image Height | 11.15 | 14.80 | 21.60 |
| Overall Lens Length | 123.73 | 123.73 | 123.73 |
| BF | 32.13 | 40.19 | 48.25 |
| d4 | 7.71 | 7.34 | 3.55 |
| d12 | 13.02 | 5.32 | 1.05 |
| d21 | 5.99 | 6.19 | 5.14 |
| d26 | 1.25 | 1.05 | 2.10 |
| d29 | 32.13 | 40.19 | 48.25 |

LENS UNIT DATA

| Lens Unit | Starting Surface | Focal Length |
|---|---|---|
| 1 | 1 | −14.97 |
| 2 | 5 | −42.81 |
| 3 | 13 | 23.42 |
| 4 | 22 | 53.48 |
| 5 | 27 | −82.35 |

NUMERICAL EXAMPLE 4

UNIT: mm
SURFACE DATA

| Surface No. | r | d | nd | νd |
|---|---|---|---|---|
| 1 | 60.163 | 2.60 | 1.83481 | 42.7 |
| 2 | 21.063 | 12.33 | | |
| 3 | 109.832 | 1.50 | 1.59522 | 67.7 |
| 4 | 17.672 | (Variable) | | |
| 5 | 150.019 | 4.20 | 1.72047 | 34.7 |
| 6 | −51.359 | 1.58 | | |
| 7 | −37.627 | 0.90 | 1.89190 | 37.1 |
| 8 | 91.089 | 2.62 | | |
| 9 | −17.827 | 0.85 | 1.49700 | 81.7 |
| 10 | 19.500 | 0.71 | | |
| 11 | 24.491 | 4.63 | 1.75520 | 27.5 |
| 12 | −127.292 | (Variable) | | |
| 13* | 32.487 | 0.05 | 1.58946 | 30.6 |
| 14 | 24.928 | 6.44 | 1.53172 | 48.8 |
| 15 | −10.792 | 0.85 | 2.00100 | 29.1 |
| 16 | −49.566 | 0.15 | | |
| 17 | 260.837 | 3.61 | 1.59270 | 35.3 |
| 18 | −19.964 | 0.06 | | |
| 19 | −83.132 | 0.90 | 1.77250 | 49.6 |
| 20 | 12.974 | 5.93 | 1.59270 | 35.3 |
| 21 | −21.635 | 0.87 | | |
| 22 (SP) | ∞ | (Variable) | | |
| 23 | 20.807 | 4.87 | 1.49700 | 81.7 |
| 24 | −19.178 | 0.15 | | |
| 25 | −22.797 | 0.80 | 2.00100 | 29.1 |
| 26 | −66.112 | (Variable) | | |
| 27 | −2019.764 | 0.80 | 1.88300 | 40.8 |
| 28 | 21.543 | 2.23 | | |
| 29 | 31.926 | 3.93 | 1.49700 | 81.7 |
| 30 | −24.775 | (Variable) | | |
| Image Plane | ∞ | | | |

ASPHERIC DATA
13th Surface
K = 0.00000e+00 A 4 = 7.64291e−06 A 6 = 4.60507e−07
A 8 = −1.46830e−08 A10 = 3.93238e−10 A12 = −3.23460e−12

VARIOUS DATA
ZOOM RATIO 2.06

| | WIDE | MIDDLE | TELE |
|---|---|---|---|
| Focal Length | 7.22 | 10.80 | 14.86 |
| Fno | 2.88 | 3.61 | 4.12 |
| Half Angle of View (°) | 56.10 | 55.97 | 55.46 |
| Image Height | 10.75 | 16.00 | 21.60 |
| Overall Lens Length | 128.99 | 128.99 | 128.99 |
| BF | 32.52 | 42.88 | 49.78 |
| d4 | 9.19 | 8.61 | 5.93 |
| d12 | 14.96 | 5.18 | 0.95 |
| d22 | 7.59 | 6.65 | 3.60 |
| d26 | 1.17 | 2.11 | 5.15 |
| d30 | 32.52 | 42.88 | 49.78 |

LENS UNIT DATA

| Lens Unit | Starting Surface | Focal Length |
|---|---|---|
| 1 | 1 | −16.14 |
| 2 | 5 | −36.44 |
| 3 | 13 | 35.25 |
| 4 | 23 | 46.70 |
| 5 | 27 | −822.66 |

### Numerical Example 5

UNIT: mm
SURFACE DATA

| Surface No. | r | d | nd | νd |
|---|---|---|---|---|
| 1 | 58.998 | 2.50 | 1.76385 | 48.5 |
| 2 | 15.716 | 16.74 | | |
| 3 | −118.695 | 1.40 | 1.59282 | 68.6 |
| 4 | 37.945 | (Variable) | | |
| 5 | 52.243 | 3.96 | 1.66565 | 35.6 |
| 6 | −30.668 | 0.59 | | |
| 7 | −22.962 | 1.00 | 1.90043 | 37.4 |
| 8 | 23.854 | (Variable) | | |
| 9 | 23.518 | 3.91 | 1.66565 | 35.6 |
| 10 | −20.591 | 1.00 | 1.49700 | 81.7 |
| 11 | 22.024 | (Variable) | | |
| 12 | 18.264 | 1.00 | 1.88300 | 40.8 |
| 13 | 11.917 | 4.60 | 1.68430 | 26.8 |
| 14 | −39.891 | 0.15 | | |
| 15 | −32.692 | 1.00 | 2.05090 | 26.9 |
| 16 | 17.207 | 5.02 | 1.59410 | 60.5 |
| 17 | −18.631 | 0.50 | | |
| 18 (SP) | ∞ | (Variable) | | |
| 19 | 20.545 | 2.96 | 1.53775 | 74.7 |
| 20 | −202.410 | (Variable) | | |
| 21 | −60.820 | 1.28 | 1.77250 | 49.6 |
| 22* | 52.786 | 0.52 | | |
| 23 | 80.866 | 3.72 | 1.49700 | 81.7 |
| 24 | −23.726 | 0.15 | | |
| 25 | −31.425 | 1.31 | 1.88300 | 40.8 |
| 26 | 52.500 | 3.91 | 1.49700 | 81.7 |
| 27 | −17.095 | (Variable) | | |
| Image Plane | ∞ | | | |

ASPHERIC DATA
22nd Surface
K = 0.00000e+00 A 4 = 2.64230e−05 A 6 = −4.03358e−09
A 8 = 7.40566e−10 A10 = −2.79295e−11 A12 = 2.33887e−13

VARIOUS DATA
ZOOM RATIO 2.03

| | WIDE | MIDDLE | TELE |
|---|---|---|---|
| Focal Length | 7.24 | 10.93 | 14.69 |
| Fno | 4.10 | 4.10 | 4.10 |
| Half Angle of View (°) | 56.05 | 55.67 | 55.77 |
| Image Height | 10.75 | 16.00 | 21.60 |
| Overall Lens Length | 127.38 | 127.38 | 127.38 |
| BF | 32.32 | 43.68 | 51.25 |
| d4 | 13.34 | 9.39 | 4.19 |
| d8 | 5.91 | 6.34 | 6.60 |
| d11 | 11.80 | 3.96 | 1.33 |
| d18 | 3.21 | 3.73 | 3.00 |
| d20 | 3.58 | 3.06 | 3.79 |
| d27 | 32.32 | 43.68 | 51.25 |

LENS UNIT DATA

| Lens Unit | Starting Surface | Focal Length |
|---|---|---|
| 1 | 1 | −14.79 |
| 2 | 5 | −25.40 |
| 3 | 9 | 64.83 |
| 4 | 12 | 41.50 |
| 5 | 19 | 34.85 |
| 6 | 21 | −442.01 |

### Numerical Example 6

UNIT: mm
SURFACE DATA

| Surface No. | r | d | nd | νd |
|---|---|---|---|---|
| 1 | 58.154 | 2.50 | 1.76385 | 48.5 |
| 2 | 15.775 | 16.08 | | |
| 3 | −425.603 | 1.40 | 1.59282 | 68.6 |
| 4 | 37.744 | (Variable) | | |
| 5 | 248.610 | 5.62 | 1.77047 | 29.7 |
| 6 | −19.550 | 1.00 | 1.95906 | 17.5 |
| 7 | −38.557 | (Variable) | | |
| 8 | −22.637 | 1.00 | 1.91354 | 36.8 |
| 9 | 28.532 | 3.85 | | |
| 10 | 28.132 | 5.18 | 1.77047 | 29.7 |
| 11 | −21.134 | 1.00 | 1.43875 | 94.7 |
| 12 | 22.654 | (Variable) | | |
| 13 | 24.356 | 6.32 | 1.68430 | 26.8 |
| 14 | −13.488 | 1.00 | 2.00100 | 29.1 |
| 15 | 28.481 | 4.91 | 1.51823 | 58.9 |
| 16 | −15.181 | 0.40 | | |
| 17 (SP) | ∞ | (Variable) | | |
| 18 | 22.580 | 3.05 | 1.49700 | 81.7 |
| 19 | −104.450 | (Variable) | | |
| 20 | −34.188 | 1.28 | 1.76450 | 49.1 |
| 21* | 87.503 | 2.04 | | |
| 22 | 32.469 | 4.26 | 1.49700 | 81.7 |
| 23 | −18.234 | 0.15 | | |
| 24 | −176.617 | 1.31 | 1.88300 | 40.8 |
| 25 | 19.236 | 3.68 | 1.49700 | 81.7 |
| 26 | −61.995 | (Variable) | | |
| Image Plane | ∞ | | | |

ASPHERIC DATA
21st Surface
K = 0.00000e+00 A 4 = 3.50880e−05 A 6 = 1.70964e−08
A 8 = 3.91104e−09 A10 = −9.58126e−11 A12 = 7.92141e−13

VARIOUS DATA
ZOOM RATIO 2.06

| | WIDE | MIDDLE | TELE |
|---|---|---|---|
| Focal Length | 7.25 | 11.01 | 14.97 |
| Fno | 4.10 | 4.10 | 4.10 |
| Half Angle of View (°) | 56.00 | 55.46 | 55.27 |
| Image Height | 10.75 | 16.00 | 21.60 |
| Overall Lens Length | 131.41 | 131.41 | 131.41 |
| BF | 32.32 | 43.52 | 50.99 |
| d4 | 11.62 | 9.61 | 3.44 |
| d7 | 1.54 | 1.48 | 2.68 |
| d12 | 13.54 | 4.41 | 1.90 |
| d17 | 4.43 | 4.43 | 3.35 |
| d19 | 1.92 | 1.92 | 3.00 |
| d26 | 32.32 | 43.52 | 50.99 |

LENS UNIT DATA

| Lens Unit | Starting Surface | Focal Length |
|---|---|---|
| 1 | 1 | −16.36 |
| 2 | 5 | 54.77 |
| 3 | 8 | −23.38 |
| 4 | 13 | 42.94 |
| 5 | 18 | 37.66 |
| 6 | 20 | −345.10 |

### Numerical Example 7

UNIT: mm
SURFACE DATA

| Surface No. | r | d | nd | νd |
|---|---|---|---|---|
| 1 | 49.099 | 2.50 | 1.95375 | 32.3 |
| 2 | 17.269 | 18.96 | | |
| 3 | −100.783 | 1.60 | 1.76385 | 48.5 |
| 4 | −8578.672 | (Variable) | | |
| 5 | 481.776 | 6.91 | 1.73037 | 32.2 |
| 6 | −25.244 | 1.00 | 1.95906 | 17.5 |
| 7 | −67.981 | (Variable) | | |
| 8* | −44.668 | 1.00 | 1.61881 | 63.9 |
| 9* | 16.516 | 0.99 | | |
| 10 | 22.668 | 4.04 | 1.92286 | 20.9 |
| 11 | −262.290 | 1.00 | 1.49700 | 81.5 |
| 12 | 26.016 | (Variable) | | |
| 13 | −33.322 | 1.00 | 1.80400 | 46.5 |
| 14 | −53.867 | (Variable) | | |
| 15 | 42.420 | 3.92 | 1.80610 | 40.7 |
| 16 | −11.822 | 1.00 | 2.00100 | 29.1 |
| 17 | −32.854 | 3.17 | | |
| 18 (SP) | ∞ | 0.99 | | |
| 19 | 60.060 | 1.76 | 1.49700 | 81.5 |
| 20 | −78.663 | 6.38 | | |
| 21 | 46.081 | 2.49 | 1.49700 | 81.5 |
| 22 | −27.161 | (Variable) | | |
| 23* | −20.417 | 1.28 | 1.88202 | 37.2 |
| 24* | −85.455 | (Variable) | | |
| 25 | 28.685 | 6.28 | 1.49700 | 81.5 |
| 26 | −22.474 | 0.15 | | |
| 27 | −29.239 | 1.31 | 2.00069 | 25.5 |
| 28 | 258.674 | 3.83 | | |
| 29 | 56.078 | 3.06 | 1.72047 | 34.7 |
| 30 | 4163.497 | (Variable) | | |
| Image Plane | ∞ | | | |

ASPHERIC DATA
8th Surface
K = 0.00000e+00 A 4 = −1.74583e−05 A 6 = 2.76581e−07
A 8 = −5.21073e−09 A10 = 4.33174e−11 A12 = −1.40705e−13
9th Surface
K = 0.00000e+00 A 4 = −3.55502e−05 A 6 = 3.18165e−07
A 8 = −1.08577e−08 A10 = 1.25034e−10 A12 = −5.41632e−13
23rd Surface
K = 0.00000e+00 A 4 = 3.92865e−04 A 6 = −7.05900e−06
A 8 = 9.81252e−08 A10 = −1.05391e−09 A12 = 7.12017e−12
24th Surface
K = 0.00000e+00 A 4 = 3.85499e−04 A 6 = −5.94595e−06
A 8 = 6.66907e−08 A10 = −4.63906e−10 A12 = 1.93438e−12

VARIOUS DATA
ZOOM RATIO 2.04

| | WIDE | MIDDLE | TELE |
|---|---|---|---|
| Focal Length | 7.22 | 11.15 | 14.71 |
| Fno | 4.10 | 4.10 | 4.10 |
| Half Angle of View (°) | 56.13 | 55.12 | 55.74 |
| Image Height | 10.75 | 16.00 | 21.60 |
| Overall Lens Length | 118.17 | 118.17 | 118.17 |
| BF | 10.00 | 19.83 | 26.38 |
| d4 | 4.63 | 6.38 | 0.96 |
| d7 | 2.05 | 3.72 | 6.56 |
| d12 | 13.07 | 4.45 | 3.57 |
| d14 | 7.36 | 3.44 | 0.83 |
| d22 | 1.90 | 2.45 | 3.45 |
| d24 | 4.55 | 3.28 | 1.80 |
| d30 | 10.00 | 19.83 | 26.38 |

LENS UNIT DATA

| Lens Unit | Starting Surface | Focal Length |
|---|---|---|
| 1 | 1 | −21.45 |
| 2 | 5 | 151.79 |
| 3 | 8 | −36.46 |
| 4 | 13 | −111.07 |
| 5 | 15 | 17.56 |
| 6 | 23 | −30.70 |
| 7 | 25 | 70.22 |

Table 1 below summarizes the values of inequalities (1) to (14) in each numerical example. The zoom lenses L0 according to numerical examples 1 to 6 satisfy all of the conditions in inequalities (1) to (14). The zoom lens L0 according to numerical example 7 also satisfies all of the conditions in inequalities (1) to (6) and inequalities (9) to (14).

TABLE 1

| | Numerical Example | | | | | | |
|---|---|---|---|---|---|---|---|
| | 1 | 2 | 3 | 4 | 5 | 6 | 7 |
| fw | 6.81 | 6.80 | 6.82 | 7.22 | 7.24 | 7.25 | 7.22 |
| fL1 | −16.55 | −14.82 | −14.97 | −16.14 | −14.79 | −16.36 | −21.45 |
| fLN | −42.17 | −38.96 | −42.81 | −36.44 | −43.47 | −41.20 | −49.52 |
| fLP | 25.84 | 30.75 | 23.52 | 26.91 | 25.88 | 26.29 | 22.85 |
| fG1 | −42.04 | −36.01 | −38.28 | −40.03 | −28.76 | −29.08 | −29.04 |
| fG2 | −37.77 | −37.09 | −35.31 | −35.60 | −48.34 | −58.42 | −133.52 |
| fLF | 47.74 | 39.68 | 53.48 | 46.70 | 34.85 | 37.66 | −30.70 |
| Skw | 30.73 | 30.90 | 32.13 | 32.52 | 32.32 | 32.32 | 10.00 |
| DLNw | 22.53 | 22.70 | 19.84 | 15.49 | 16.38 | 19.20 | 16.98 |
| MLP | −18.70 | −17.94 | −16.98 | −21.25 | −19.14 | −19.75 | −16.38 |
| DSPw | 23.51 | 19.10 | 13.83 | 21.54 | 20.63 | 22.12 | 28.81 |
| ndG1 | 1.85 | 1.85 | 1.85 | 1.83 | 1.76 | 1.76 | 1.95 |
| R1 | 48.93 | 55.48 | 52.86 | 60.16 | 59.00 | 58.15 | 49.10 |
| R2 | 20.28 | 19.37 | 19.81 | 21.06 | 15.72 | 15.78 | 17.27 |
| Yta | 21.64 | 21.60 | 21.60 | 21.60 | 21.60 | 21.60 | 21.60 |
| Ywa | 11.15 | 11.15 | 11.15 | 10.75 | 10.75 | 10.75 | 10.75 |
| (1) | −1.36 | −1.53 | −1.33 | −0.96 | −1.11 | −1.17 | −0.79 |
| (2) | −1.13 | −1.21 | −1.13 | −1.32 | −1.29 | −1.21 | −0.76 |
| (3) | −2.43 | −2.18 | −2.20 | −2.23 | −2.04 | −2.26 | −2.97 |
| (4) | 2.55 | 2.63 | 2.86 | 2.26 | 2.94 | 2.52 | 2.31 |
| (5) | 2.54 | 2.43 | 2.56 | 2.48 | 1.94 | 1.78 | 1.35 |
| (6) | 1.11 | 0.97 | 1.08 | 1.12 | 0.60 | 0.50 | 0.22 |
| (7) | 7.00 | 5.83 | 7.84 | 6.47 | 4.82 | 5.19 | −4.25 |
| (8) | −2.88 | −2.68 | −3.57 | −2.89 | −2.36 | −2.30 | 1.43 |
| (9) | −0.64 | −0.48 | −0.64 | −0.60 | −0.57 | −0.62 | −0.94 |
| (10) | 4.51 | 4.54 | 4.71 | 4.50 | 4.47 | 4.46 | 1.39 |
| (11) | 0.77 | 0.62 | 0.43 | 0.66 | 0.64 | 0.68 | 2.88 |
| (12) | 1.85 | 1.85 | 1.85 | 1.83 | 1.76 | 1.76 | 1.95 |
| (13) | 2.42 | 2.07 | 2.20 | 2.08 | 1.73 | 1.74 | 2.09 |
| (14) | 1.94 | 1.94 | 1.94 | 2.01 | 2.01 | 2.01 | 2.01 |

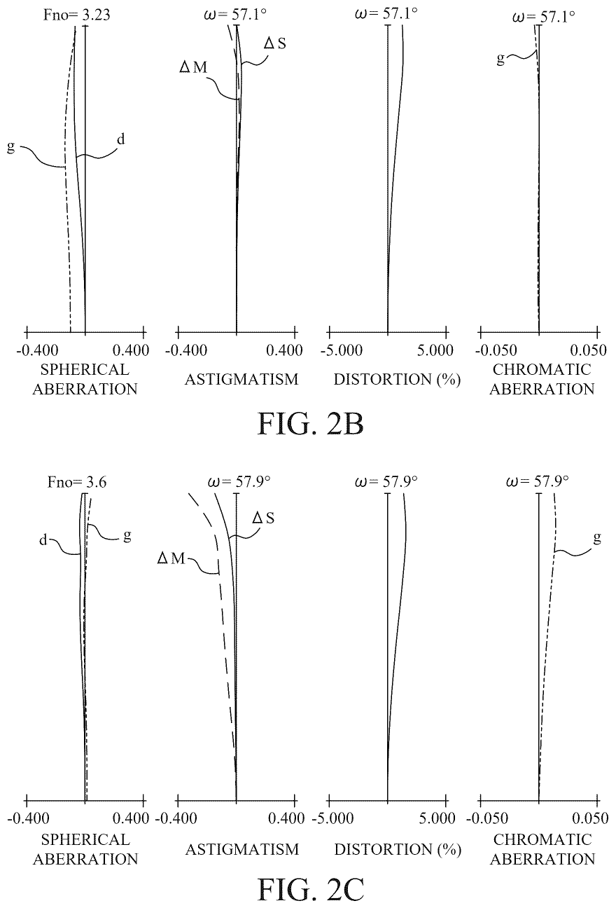

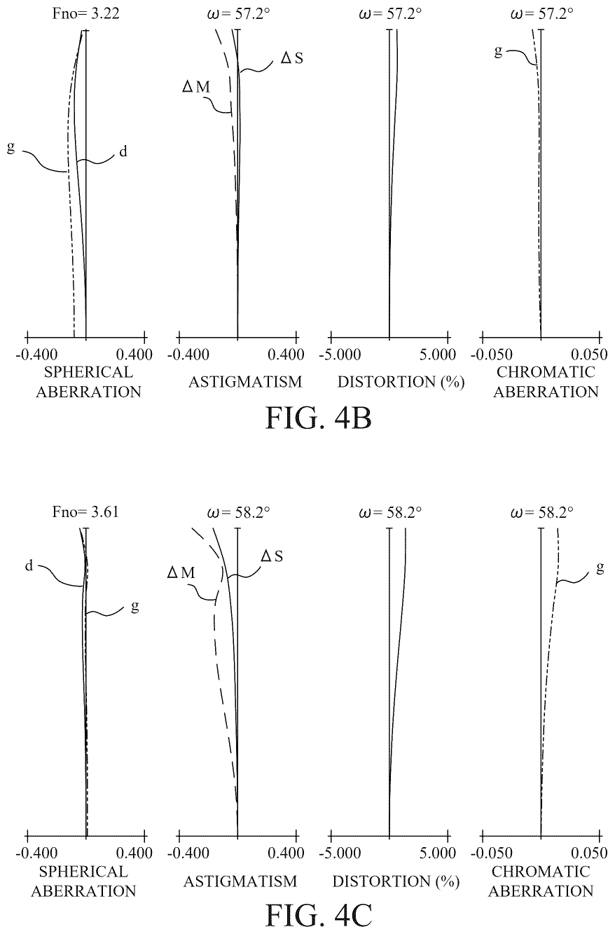

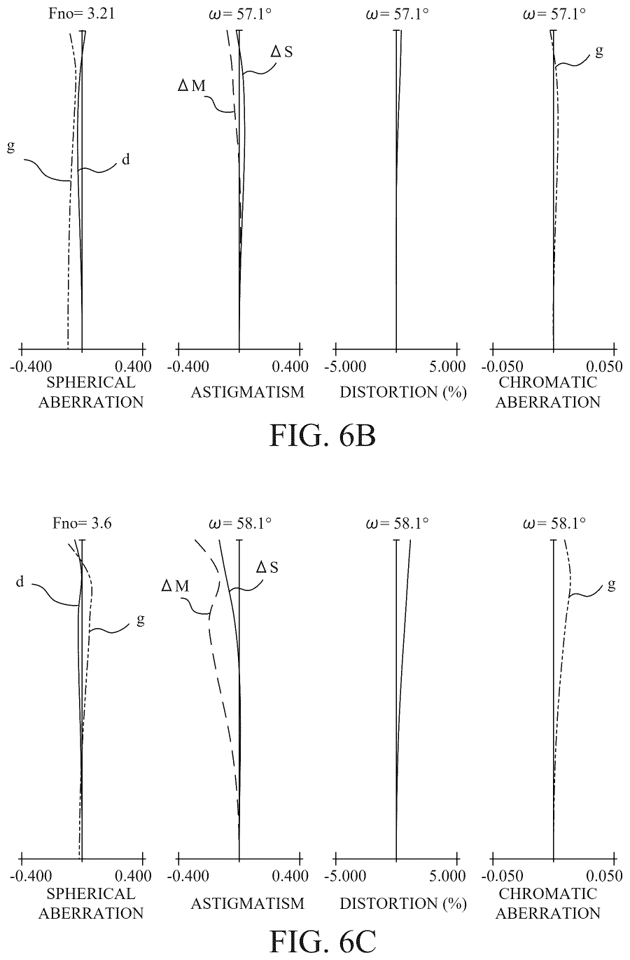

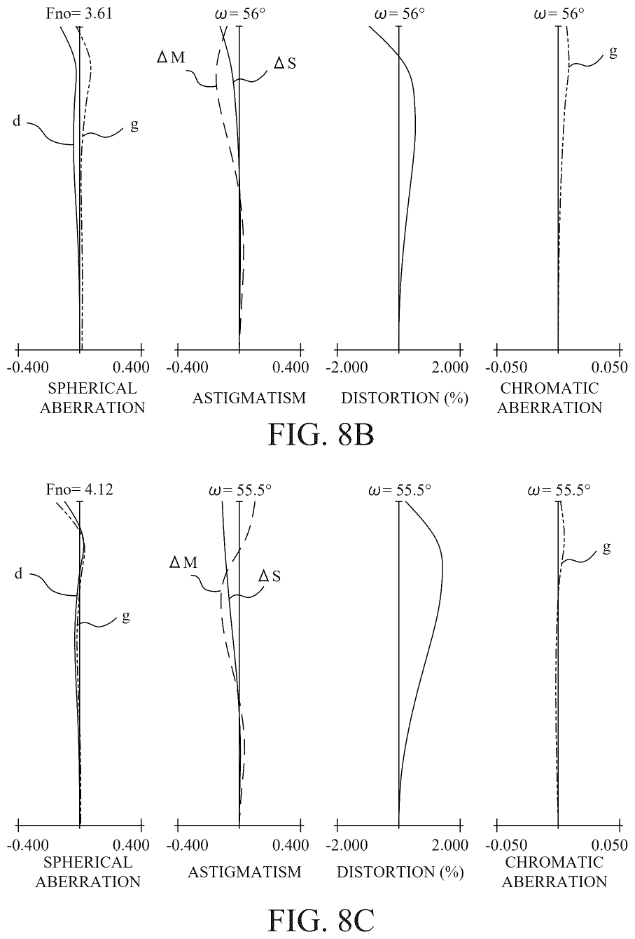

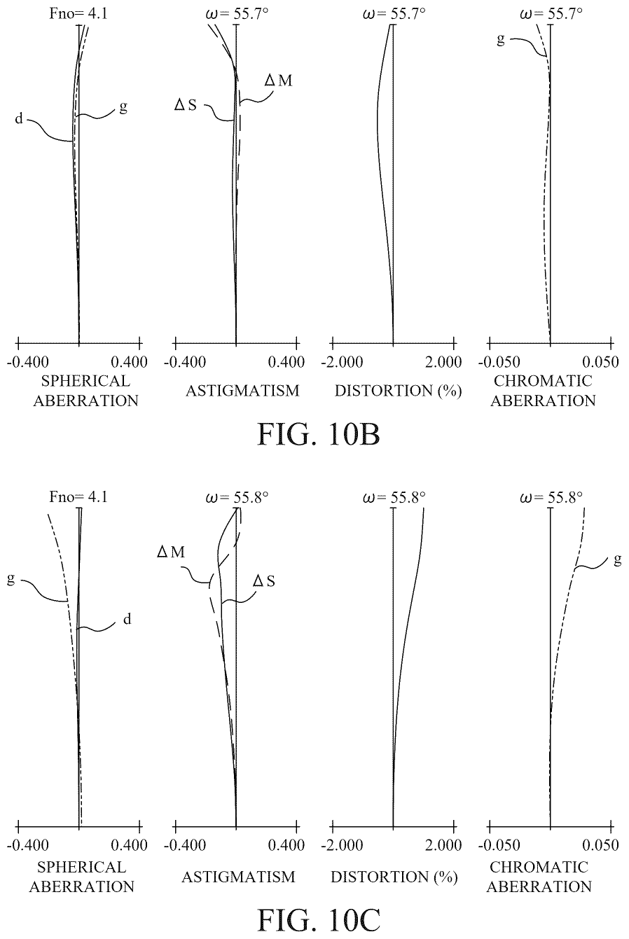

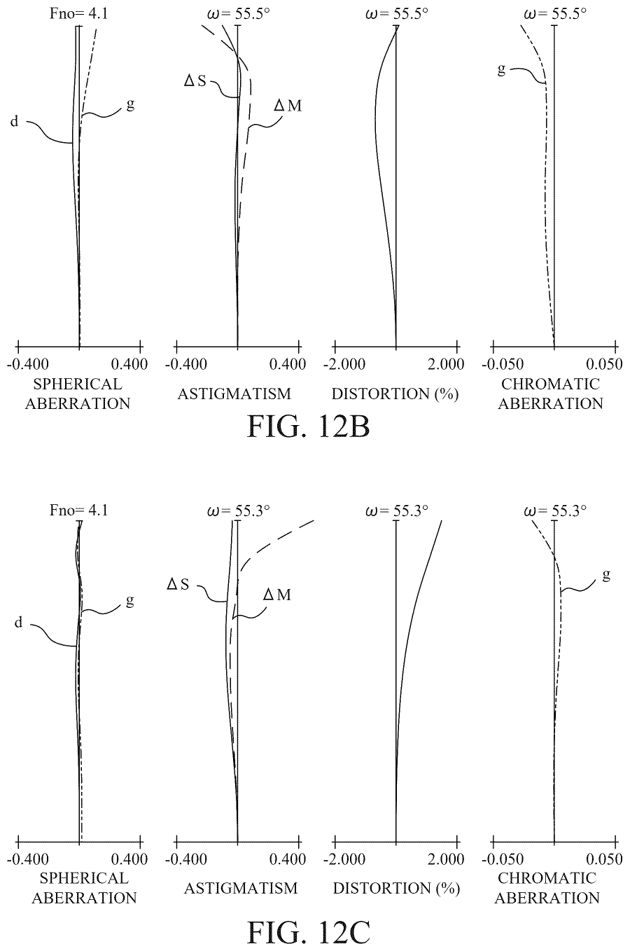

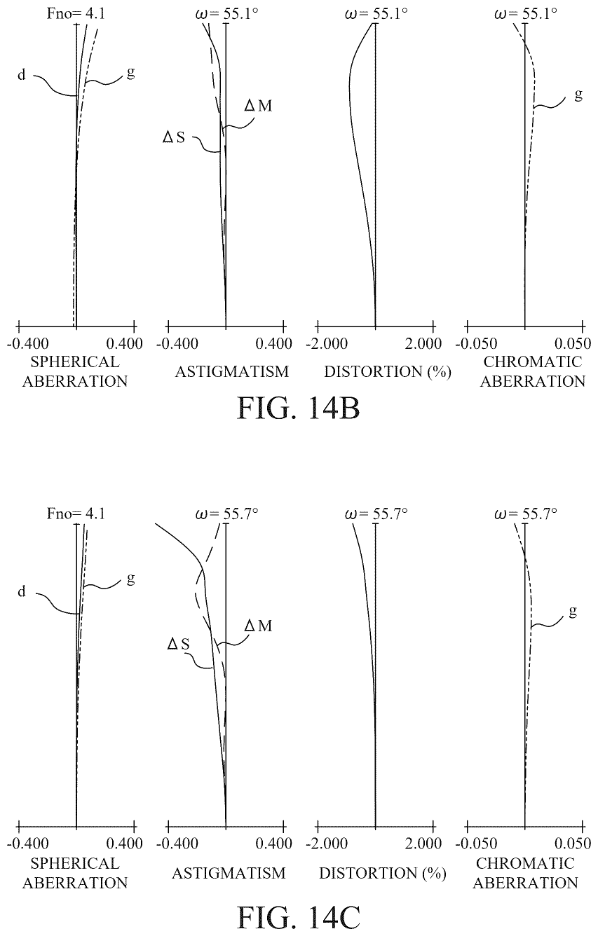

FIGS. 2A, 2B, 2C, 4A, 4B, 4C, 6A, 6B, 6C, 8A, 8B, 8C, 10A, 10B, 10C, 12A, 12B, 12C, 14A, 14B, and 14C illustrate the longitudinal aberration (spherical aberration, astigmatism, distortion, and chromatic aberration) of the zoom lenses L0 according to numerical examples 1 to 7 in an in-focus states at infinity. FIGS. 2A, 4A, 6A, 8A, 10A, 12A, and 14A illustrate the longitudinal aberration at the wide-angle end, FIGS. 2B, 4B, 6B, 8B, 10B, 12B, and 14B illustrate the longitudinal aberration at the intermediate zoom position, and FIGS. 2C, 4C, 6C, 8C, 10C, 12C, and 14C illustrate the longitudinal aberration at the telephoto end.

In the spherical aberration diagrams, Fno represents an F-number. A solid line illustrates a spherical aberration amount for the d-line (wavelength 587.6 nm), and an alternate long and two short dashes line illustrates a spherical aberration amount for the g-line (wavelength 435.8 nm). In the astigmatism diagram, a solid line S represents an astigmatism amount on a sagittal image plane, and a dashed line M represents an astigmatism amount on a meridional image plane. The distortion diagram illustrates a distortion amount for the d-line. The chromatic aberration diagram illustrates a lateral chromatic aberration amount for the g-line. o represents a half angle of view (°) calculated by paraxial calculation.

### Image Pickup Apparatus

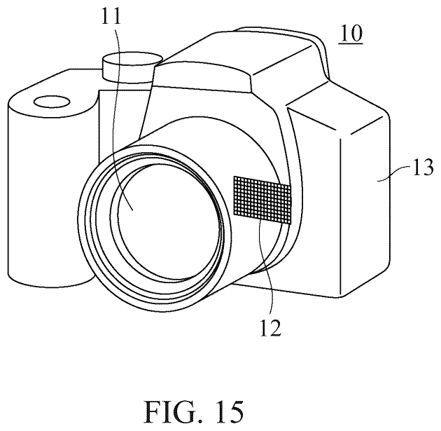

FIG. 15 illustrates an image pickup apparatus (digital still camera) 10 that uses the zoom lens L0 according to any one of Examples 1 to 7 as its imaging optical system. The image pickup apparatus 10 includes a camera body 13, an imaging optical system 11 that is one of the zoom lenses according to Examples 1 to 7, and an image sensor 12, such as a CCD sensor or CMOS sensor, which captures an optical image formed by the imaging optical system 11.

By using a compact zoom lens with excellent optical performance as the imaging optical system 11, the image pickup apparatus 10 can produce high-quality images.

Electrically correcting various aberrations such as distortion and chromatic aberration in the image acquired by the image sensor 12 can improve the image quality of the output image.

An imaging system such as a surveillance camera system may include a camera having the zoom lens L0 according to any one of the examples and a control unit that controls the zoom lens L0.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide a zoom lens that has a wide angle of view and good optical performance.

This application claims the benefit of Japanese Patent Application No. 2025-005885, filed on Jan. 16, 2025, which is hereby incorporated by reference herein in its entirety.

What is claimed is:

1. A zoom lens comprising, in order from an object side to an image side:
a first lens unit with negative refractive power;
an intermediate group with negative refractive power including at least one lens unit; and
a rear group with positive refractive power including a plurality of lens units,
wherein each distance between adjacent lens units changes,
wherein the first lens unit does not move during zooming,
wherein an air gap between the intermediate group and the rear group is maximized at a wide-angle end,
wherein the intermediate group includes a plurality of negative lenses, and
wherein the following inequalities are satisfied:
$$- 5. \leq DLNw / fL 1 \leq - 0.7$$
$$0.7 \leq MLP / fL 1 \leq 5.$$
where fL1 is a focal length of the first lens unit, DLNw is a distance on an optical axis from a lens surface of the intermediate group closest to an object at the wide-angle end to a lens surface of the intermediate group closest to an image plane at the wide-angle end, and MLP is a maximum moving amount among the plurality of lens units included in the rear group during zooming from the wide-angle end to a telephoto end.

2. The zoom lens according to claim 1, wherein the following inequality is satisfied:
$$- 3.3 \leq fL 1 / fw \leq - 1.7$$
where fw is a focal length of the zoom lens at the wide-angle end.

3. The zoom lens according to claim 1, wherein the following inequality is satisfied:
$$2. \leq fLNw / fL 1 \leq 3.5$$
where fLNw is a focal length of the intermediate group at the wide-angle end.

4. The zoom lens according to claim 1, wherein the following inequality is satisfied:
$$1.4 \leq fG 1 / fL 1 \leq 3.$$
where fG1 is a focal length of the first lens closest to the object in the first lens unit.

5. The zoom lens according to claim 1, wherein the following inequality is satisfied:
$$0.2 \leq fG 1 / fG 2 \leq 1.6$$
where fG1 is a focal length of the first lens closest to the object in the first lens unit, and fG2 is a focal length of a second lens adjacent to and disposed on the image side of the first lens.

6. The zoom lens according to claim 1, wherein the rear group includes a focus lens unit that moves during focusing, and
wherein the following inequality is satisfied:
$$3.5 \leq fLF / fw \leq 15.$$
where fLF is a focal length of the focus lens unit, and fw is a focal length of the zoom lens at the wide-angle end.

7. The zoom lens according to claim 1, wherein the rear group includes a focus lens unit that moves during focusing, and
wherein the following inequality is satisfied:
$$- 4.1 \leq fLF / fL 1 \leq - 1.8$$
where fLF is a focal length of the focus lens unit.

8. The zoom lens according to claim 1, wherein the following inequality is satisfied:
$$- 1.3 \leq fL 1 / fLPw \leq - 0.4$$
where fLPw is a focal length of the rear group at the wide-angle end.

9. The zoom lens according to claim 1, wherein the following inequality is satisfied:
$$1.3 \leq Skw / fw \leq 6.0$$
where Skw is an air-equivalent distance on the optical axis from a lens surface of the zoom lens closest to the image plane to the image plane at the wide-angle end, and fw is a focal length of the zoom lens at the wide-angle end.

10. The zoom lens according to claim 1, wherein the rear group includes an aperture stop, and
wherein the following inequality is satisfied:
$$0.39 \leq DSPw / Skw \leq 2.90$$
where DSPw is a distance on the optical axis from the aperture stop to a lens surface in the rear group closest to the image plane, and fw is a focal length of the zoom lens at the wide-angle end.

11. The zoom lens according to claim 1, wherein the following inequality is satisfied:
$$1.65 \leq ndG 1 \leq 2.2$$
where ndG1 is a refractive index for d-line of a first lens in the first lens unit disposed closest to the object.

12. The zoom lens according to claim 1, wherein a first lens disposed closest to the object in the first lens unit has a meniscus shape with a convex surface toward the object side, and
wherein the following inequality is satisfied:
$$1. 3 \leq ( R 1 + R 2 ) / ( R 1 - R 2 ) \leq 3.$$
where R1 is a radius of curvature of an object-side lens surface of the first lens, and
R2 is a radius of curvature of an image-side lens surface of the first lens.

13. The zoom lens according to claim 1, wherein the following inequality is satisfied:
$$1.5 \leq Yta / Ywa \leq 3.$$
where Yta is a maximum effective image height at a telephoto end, and Ywa is a maximum effective image height at the wide-angle end.

14. The zoom lens according to claim 1, wherein the first lens unit consists of two negative lenses.

15. The zoom lens according to claim 1, wherein the rear group includes a focus lens unit that moves during focusing, and
wherein the focus lens unit consists of two or fewer lenses.

16. The zoom lens according to claim 1, wherein the rear group includes three or more lens units that move during zooming.

17. The zoom lens according to claim 1, further comprising:
an aperture stop; and
a focus lens unit that moves during focusing, and is disposed on the image side of the aperture stop.

18. The zoom lens according to claim 1, wherein the zoom lens consists of, in order from the object side to the image side:
the first lens unit;
a second lens unit with negative refractive power;
a third lens unit with positive refractive power;
a fourth lens unit with positive refractive power; and
a fifth lens unit with negative refractive power.

19. The zoom lens according to claim 1, wherein zoom lens consists of, in order from the object side to the image side:
the first lens unit;
a second lens unit with negative refractive power;
a third lens unit with positive refractive power;
a fourth lens unit with positive refractive power;
a fifth lens unit with positive refractive power; and
a sixth lens unit with negative refractive power.

20. The zoom lens according to claim 1, wherein the zoom lens consists of, in order from the object side to the image side:
the first lens unit;
a second lens unit with positive refractive power;
a third lens unit with negative refractive power;
a fourth lens unit with positive refractive power;
a fifth lens unit with positive refractive power; and
a sixth lens unit with negative refractive power.

21. The zoom lens according to claim 1, wherein the zoom lens consists of, in order from the object side to the image side:
the first lens unit;
a second lens unit with positive refractive power;
a third lens unit with negative refractive power;
a fourth lens unit with negative refractive power;
a fifth lens unit with positive refractive power;
a sixth lens unit with negative refractive power; and
a seventh lens unit with positive refractive power.

22. An image pickup apparatus comprising:
a zoom lens; and
an image sensor for capturing an image of an object through the zoom lens,
wherein the zoom lens includes, in order from an object side to an image side:
a first lens unit with negative refractive power;
an intermediate group with negative refractive power including at least one lens unit; and
a rear group with positive refractive power including a plurality of lens units,
wherein each distance between adjacent lens units changes,
wherein the first lens unit does not move during zooming,
wherein an air gap between the intermediate group and the rear group is maximized at a wide-angle end,
wherein the intermediate group includes a plurality of negative lenses, and
wherein the following inequalities are satisfied:
$$- 5. \leq DLNw / fL 1 \leq - 0.7$$
$$0.7 \leq MLP / fL 1 \leq 5.$$
where fL1 is a focal length of the first lens unit, DLNw is a distance on an optical axis from a lens surface of the intermediate group closest to an object at the wide-angle end to a lens surface of the intermediate group closest to an image plane at the wide-angle end, and MLP is a maximum moving amount among the plurality of lens units included in the rear group during zooming from the wide-angle end to a telephoto end.
